(19) United States
(12) Patent Application Publication
(10) Pub. No.: US 2002/0113342 A1
(43) Pub. Date: Aug. 22, 2002

(54) Method of making an elastic pad

(76) Inventor: Shuang Chu Tsai, Taichung (TW)

Correspondence Address: Liberty Patent & Trademark Office, P.O. Box 590, Taichung City, 406, TW

(21) Appl. No.: 10/073,115

(22) Filed: Feb. 12, 2002

Related U.S. Application Data
(63) Continuation-in-part of application No. 09/398,928, filed on Sep. 17, 1999, now abandoned.

(51) Int. Cl. B29C 49/00

(52) U.S. Cl. 264/553; 264/571; 264/316

(57) ABSTRACT

A method of making an elastic pad for a sole in footwear has the following steps. Form an elastomer, a positioning rod is extended from the elastomer, the positioning rod supports and positions the elastomer in a mold. Form gasbags, by enclosing the elastomer with heated plastic film in mold then close the halves of mold. An elastic pad is then formed. Trim the elastic pad along the pressed periphery which is formed by the mold closure on excessive plastic film.

### BACKGROUND OF THE INVENTION

The present invention relates to a method of making an elastic pad. More particularly, the present invention relates to a method of making an elastic pad for a sole in footwear.

Referring to FIG. 1, a conventional method of making an elastic pad for a sole in footwear is described as follows:

Step 101: From an elastomer, please also refer to FIG. 2 for elastomer 91.

Step 102: Form a hollow block in a mold, please refer to FIG. 3, a hollow block is formed from a mold, it can be designated for upper film 92 and lower film 93.

Step 103: Separate the hollow block into two portions; the upper film 92 and lower film 93, then dispose the elastomer 91 between upper film 92 and lower film 93 as shown in FIG. 2

Step 104: Adhere the upper film 92, the elastomer 91, and the lower film 93 together, put the elastomer 91 right in between upper film 92 and lower film 93.

Step 105: Weld the upper film 92, the elastomer 91, and the lower film 93 together by ultra sonic welding to ensure all devices are sealed.

Step 106: Cut excessive portion of the upper film 92 and the lower film 93 of above welded device to form an elastic pad.

Step 107: Trim the elastic pad.

There are several disadvantages caused by above method of making an elastic pad for sole in footwear:

1. The adhering portions of the upper film 92, the elastomer 91, and the lower film 93 will be disengaged after a long period of usage.

2. Low production speed due to multiple and complex procedures, most of the procedures must be executed by hand work,

3. Low yield rate, because the production is very rely on skilled human work. It is hard to keep the consistence of quality.

4. Easy to get dirt from human operation in the procedure of adhering.

5. The welded device form step 105 will be easily broken in following steps if all the elements in welded device are not perfectly sealed and secured.

6. The welded device from step 105 will also be easily damaged in following steps because the sealing positions of upper film 92 and lower film 93 are not matched.

### SUMMARY OF THE INVENTION

An object of the present invention is to provide a method of making an elastic pad, which can reduce production steps significantly.

Accordingly, a method of making an elastic pad for sole in footwear comprises the following steps. From an elastomer. A positioning rod extends from the ealstomer. The positioning rod supports/positions the elastomer in a mold. From gasbags, by enclosing the elastomer with heated plastic film in mold. A melted plastic film is extruded into the mold via an extruder. The melted plastic film encloses the elastomer. A vacuum pump extracts the mold into a vacuum condition. The melted plastic film forms a large number of gasbags. An elastic pad is formed.. Trim the elastic pad.

### BRIEF DESCRIPTION OF THE DRAWINGS

FIG. 1 is a flow diagram of a method of making an elastic pad of the prior art;

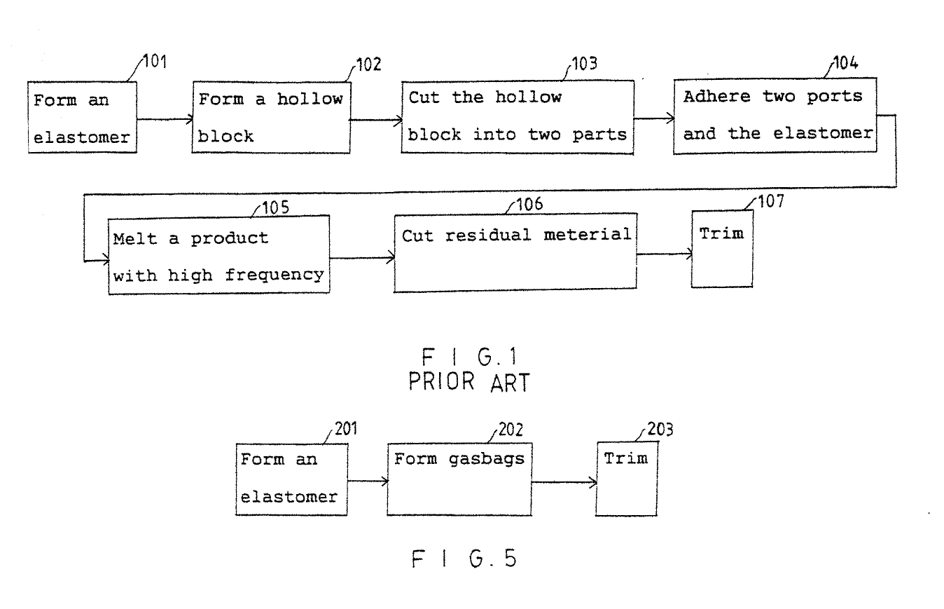

FIG. 2 is a perspective exploded view of an elastic pad of the prior art;

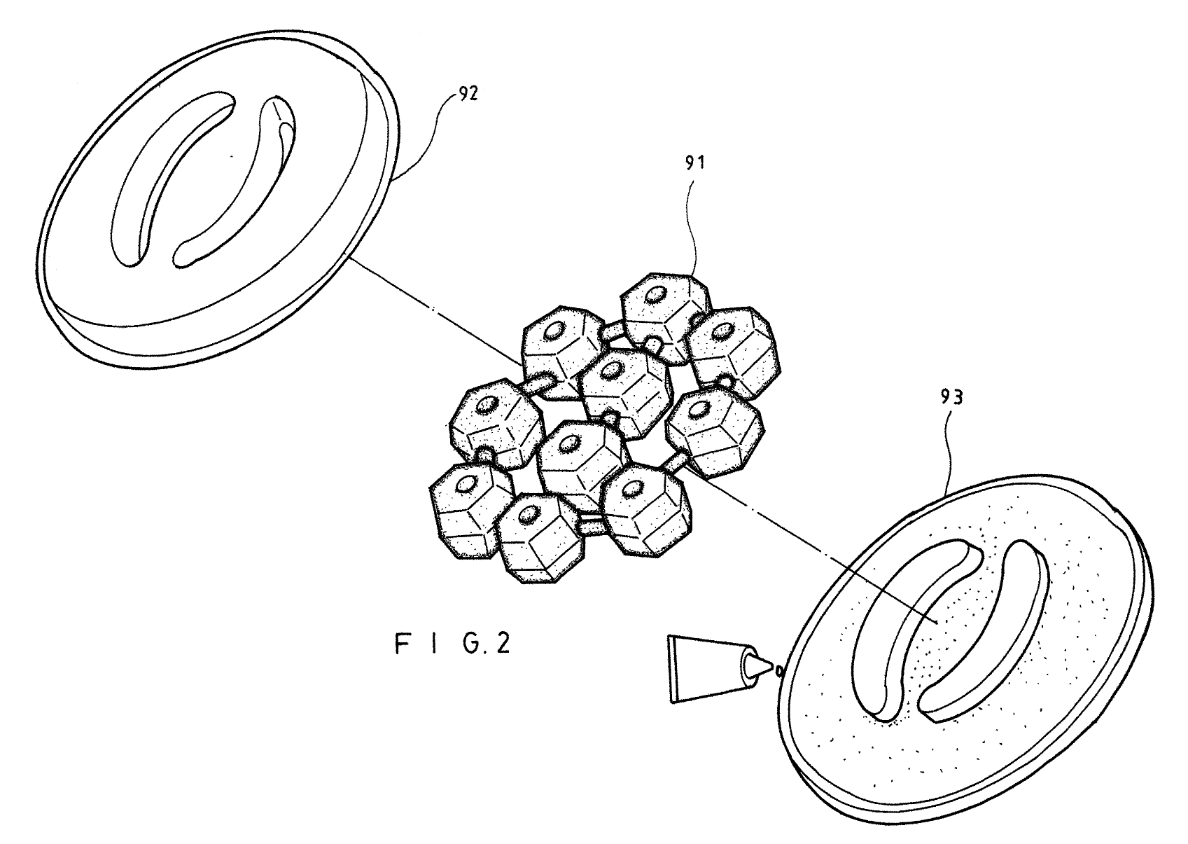

FIG. 3 is a sectional schematic view illustrating a formation of a hollow block of the prior art;

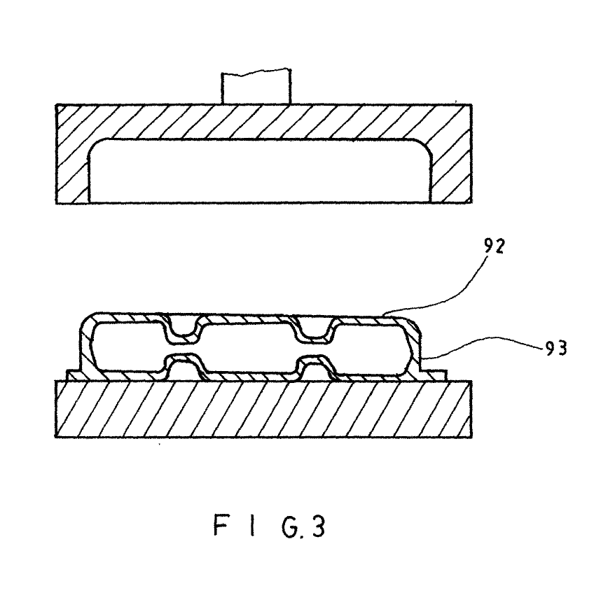

FIG. 4 is a sectional schematic view illustrating an upper film of the prior art is cut in order to remove a residual material;

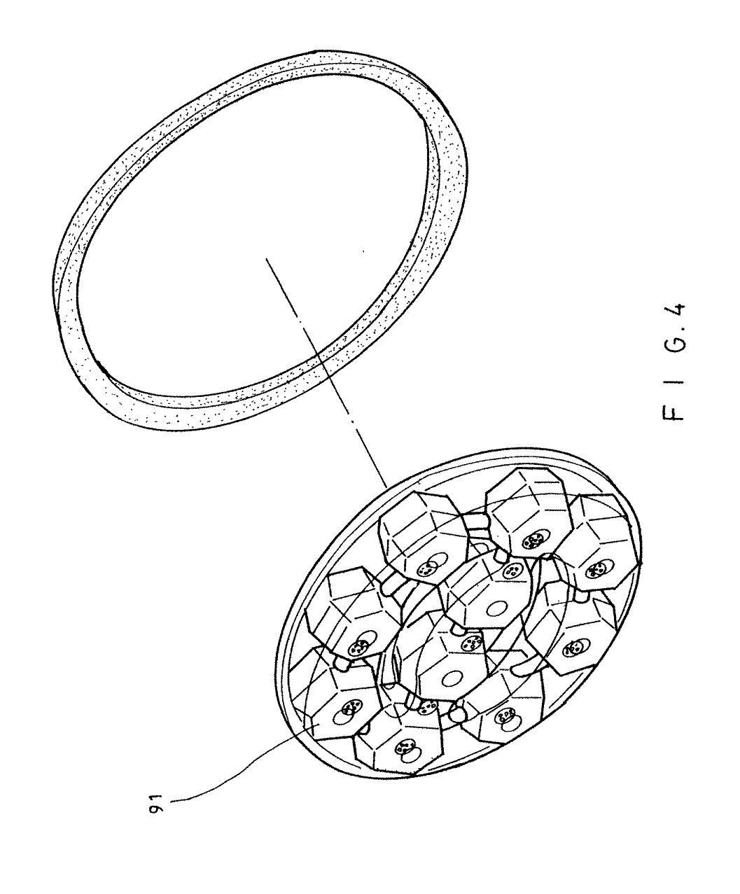

FIG. 5 is a flow diagram of a method of making an elastic pad of a preferred embodiment in accordance with the present invention;

FIG. 6 is a schematic view illustrating a formation of a preferred embodiment in accordance with the present invention; and

FIG. 7 is a perspective view of an elastic pad of a preferred embodiment in accordance with the present invention.

FIG. 8 is a schematic view illustrating a formation which two halves of molds closed and enclosed the elastomer of preferred embodiment.

### DETAILED DESCRIPTION OF PREFERRED EMBODIMENTS

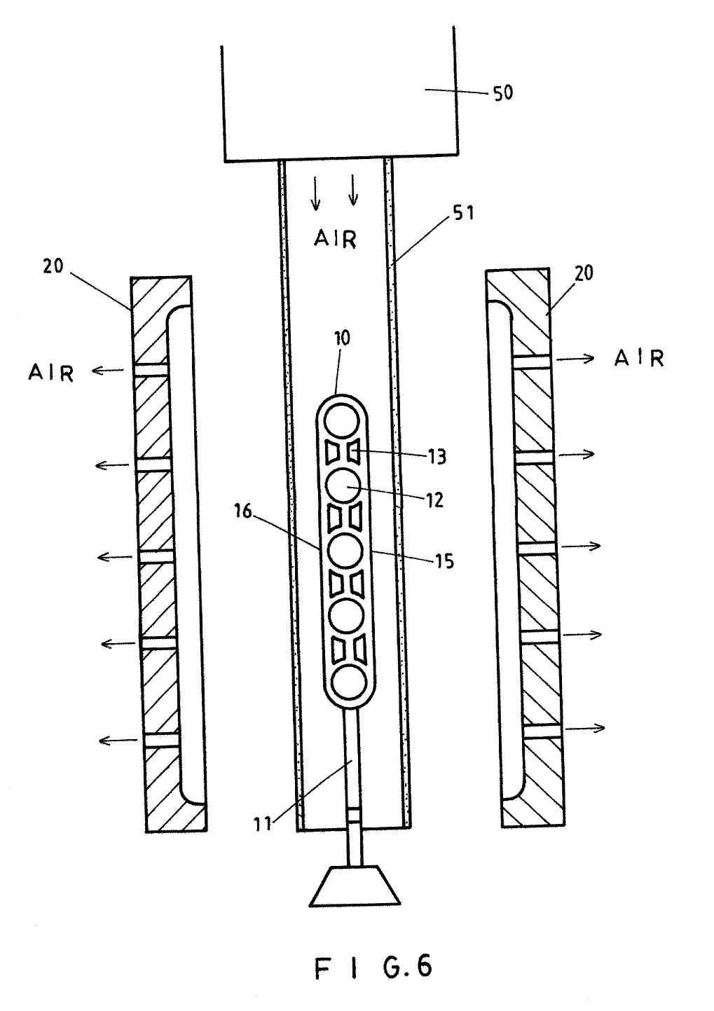

As shown in FIG. 5 showing the flow chart of this invention, the subject matter of elastic pad can be produced by three processes: Form an elastomer→Form gasbags→Trim; wherein

1). The first process of “form an elastomer” (201):

As shown in FIG. 9, the invention of elastomer (10) is a monobloc formed by injection molding or extrusion, including a positioning rod (11) located at an appropriate location on the elastomer (10). In the preferred embodiment, the elastomer (10) is, but not limited to, a plastic block with a specified thickness. The block is injection molded or extruded with the formation of a first face (15), and a second face (16) that is at the far side of the first face (15). Between the first face (15) and the second face (16) is the formation of a plurality of holes (12) and (13). All the holes (12) and (13) have an open end on the outside. At an appropriate location, such as one end of the elastomer (10) is the extension of a positioning rod (11). The positioning rod (11) serves to support the elastomer (10) and position the elastomer (10) inside the mold (20).

2). The second process of “form gasbags” (202):

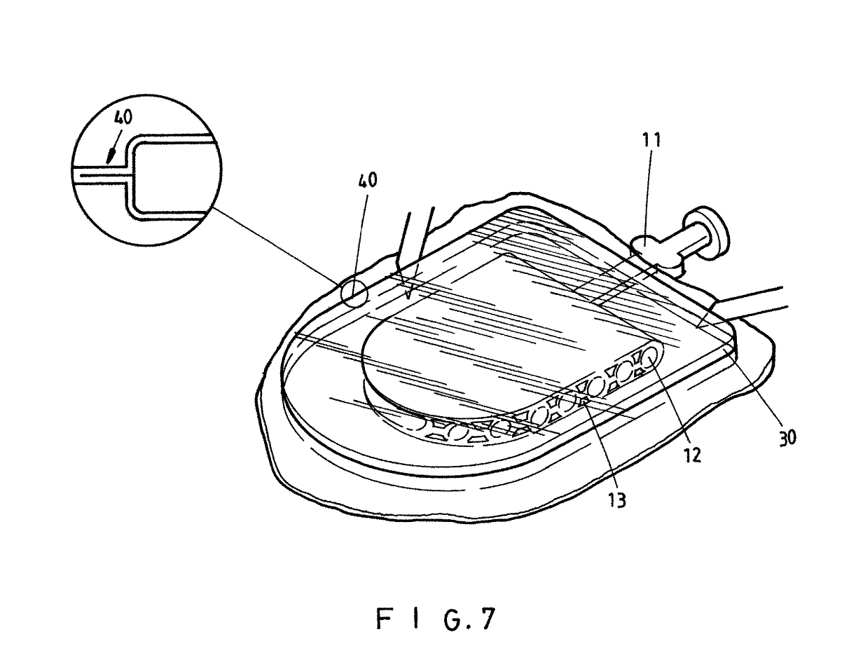

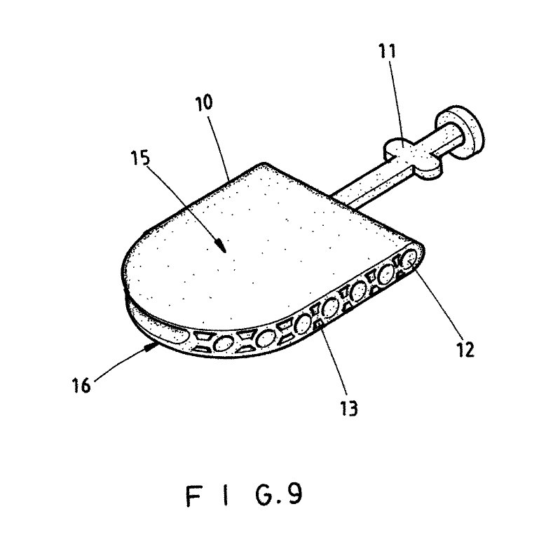

As shown in FIG. 6 and FIG. 8, the plastic film or plastic sheet (51) provided by the forming machine or injection molder is fed into respective open mold (20). The plastic film or plastic sheet (51) is cylinder shaped, with air continuously blowing into its center to spread the plastic film or plastic sheet (51). The spread plastic film or plastic sheet (51) envelops the exterior of the elastomer (10), facing the first face (15) and the second face (16) of the elastomer (10). Then the mold (20) is closed, but air is still blown into the center of the plastic film or plastic sheet (51). To enable the plastic film or plastic sheet (51) to firmly adhere to the inside wall of the mold (20), air is extracted by a vacuum pump out of the mold (20) to form a vacuum. Therefore, with air spreading the plastic film or plastic sheet (51) from within and vacuum suction sucking from without, the plastic film or sheet (51) will be able to wrap the elastomer (10) tightly in the shape of the mold (20). Because of the air filled between the plastic film or plastic sheet (51) and the elastomer (10), a gasbag (30) is formed between the plastic film or plastic sheet (51) and the elastomer (10). When the plastic film or plastic sheet (51) is fed into the mold (20), it also wraps over the positioning rod (11) at one end of the elastomer (10), and during the process when the gasbag (30) is formed, the plastic film or plastic sheet (51) also wraps the positioning rod (11) hermetically. Thereby, the gasbag (3) has better structural properties and better protection against leak, and so the elastic pad can be processed by automated production. Of course, the mold (2) can have pressed margins at the rim of the gasbag (30), so that the excessive materials of the gasbag (30) and positioning rod (11) form a pressed periphery (40) after the hot-pressing process, for the purpose of partition and trimming.

3) Trim(203):

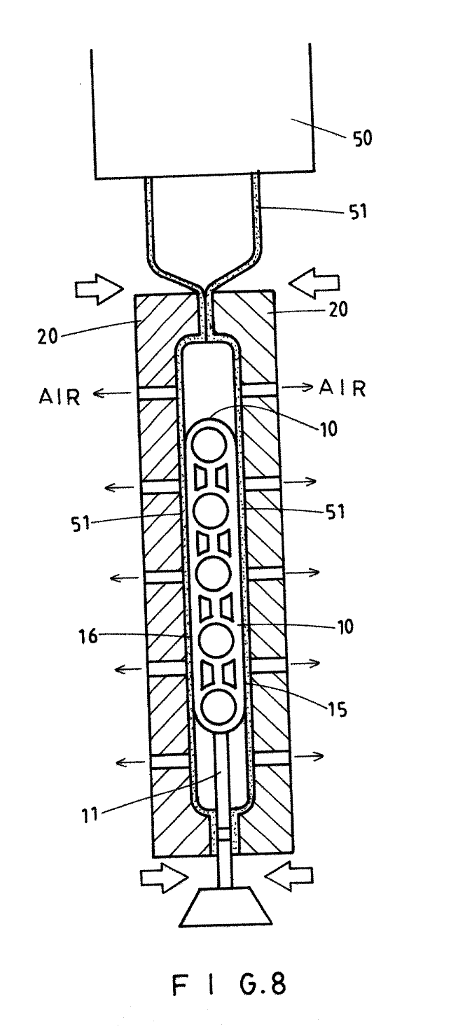

As shown in FIG. 7, a cutter blade is used to cut the pressed periphery (40) and easily remove the margins of excessive materials. Because of the precision hot-press process on the mold (20), the assembly of this invention could have quite high stability to prevent any piercing or breakage.

According to the above disclosed method of making an elastic pad for sole in footwear, the present invention has overcome the disadvantages generates from conventional production methods.

The present invention is not limited to the above embodiment but various modifications thereof may be made. Furthermore, various changes in form and detail may be made without departing from the scope of the present invention.

I claim:

1. A method of making an elastic pad for sole in footwear comprising steps of:
Forming an elastomer→Forming gasbag→Trimming;
Forming an elastomer: said elastomer, formed by an injection molder or an extrusion molder, is a block with a specified thickness, forming a first face and a second face that is on the far side of the first face, between the first face and the second face being the formation of a plurality of holes, the holes being opened to the outside, and at an appropriate location being a positioning rod, said positioning rod being positioned in the mold;
Forming gasbag: the cylindrical plastic film or plastic sheet is fed from the injection molder or extrusion molder into the open mold, enveloping the elastomer, with air being blown into the center of the plastic film or plastic sheet, then the mold is closed and air extracted by a vacuum pump to make it a vacuum state, meanwhile, the plastic film or plastic sheet wraps over the elastomer in the exact shape of the mold, with air filled between the plastic film or plastic sheet and the elastomer, the plastic film or plastic sheet also wraps the positioning rod at one end of the elastomer, forming a gasbag, hermetically enveloping the positioning rod, enabling better structural properties of the gasbag and better protection against leak;
Trimming: excessive materials on the margins of the gasbag and the positioning rod are cut off to complete the elastic pad.

2. A method of making an elastic pad for sole in footwear cited in claim 1, wherein the mold for forming gasbags has a pressed periphery around gasbags, to enveloping the position rod and gasbags by heat pressing the excessive plastic material.
